(19) United States
(12) Patent Application Publication
(10) Pub. No.: US 2025/0155081 A1
(43) Pub. Date: May 15, 2025

(54) BREATHING APPARATUS, A PRESSURE VESSEL AND ASSOCIATED METHODS OF MANUFACTURE

(71) Applicant: Drager Safety AG & Co. KGaA, Lubeck (DE)

(72) Inventors: Paul James Ringer, Consett (GB); Andrew Richard Olds, Whitley Bay (GB); Craig Stuart Blenkiron, Prudhoe (GB)

(21) Appl. No.: 18/940,571

(22) Filed: Nov. 7, 2024

(30) Foreign Application Priority Data
Nov. 9, 2023 (EP) 23208879.9

(51) Int. Cl. F17C 1/16

(52) U.S. Cl. CPC F17C 1/16; F17C 2203/011; F17C 2203/0604; F17C 2203/0624; F17C 2203/0675; F17C 2203/0697; F17C 2270/079

(57) ABSTRACT

Disclosed is a breathing apparatus comprising a pressure vessel. The pressure vessel may comprise a composite shell formed from a plurality of fibres and a matrix comprising a resin material and graphene particles. The pressure vessel may comprise at least one permeation barrier layer comprising graphene microparticles or graphene nanoparticles provided on an outer surface of the structural shell or on an outer surface of the liner. Methods of manufacture for pressure vessels are also disclosed.

### TECHNICAL FIELD

The present disclosure concerns a breathing apparatus, a pressure vessel and associated methods of manufacture. In particular, the present disclosure may relate to a breathing apparatus having a pressure vessel with reduced permeability to chemical, biological, radiological and nuclear (CBRN) contaminants and improved mechanical properties.

### BACKGROUND

Pressure vessels are used with breathing apparatus to store clean breathing air for the user to breathe when they are entering environments where the ambient gases are not breathable, such as in fires and contaminated areas.

When a breathing apparatus is being used in an environment due to the presence of chemical, biological, radiological and/or nuclear (CBRN) contaminants, it is important that these contaminants may not be breathed in by the user as this can be fatal. For cylinders having a metallic liner (Type Ill), the liner inherently prevents CBRN permeation into the cylinder through the cylinder wall.

However, for newer cylinder designs which may have a polymeric liner (Type IV) or no liner (Type V), the lack of a metallic barrier can increase the risk of CBRN contamination inwardly through the cylinder wall. Similarly, outward permeation of breathable air, through the cylinder wall to the exterior of the cylinder, may also occur.

Further, the lack of a metallic liner may reduce the overall mechanical properties (e.g., impact resistance) of a Type IV or Type V cylinder.

Improvements are therefore desired in the art of pressure vessels for breathing apparatus.

### STATEMENTS OF INVENTION

According to an aspect, there is provided a breathing apparatus. The breathing apparatus may comprise a pressure vessel manufactured according to any other aspect and/or may comprise a pressure vessel according to any other aspect. The present aspect may form part of and/or be used in conjunction with any other aspect.

According to an aspect, there is provided a pressure vessel, e.g., for a breathing apparatus. The pressure vessel may be a composite pressure vessel. The pressure vessel may comprise a composite shell, e.g., a fibre-reinforced polymer composite shell. The composite shell may be formed from a plurality of fibres and a matrix comprising a resin material. The composite shell may comprise graphene particles, e.g., graphene flakes. The graphene flakes may form a layer of graphene.

The pressure vessel may be a breathing air vessel. The pressure vessel may be for an SCBA (self-contained breathing apparatus). The pressure vessel may be for a CCBA (closed circuit breathing apparatus). The graphene particles may be in the resin material, such as dispersed within the resin material. The present aspect may form part of and/or be used in conjunction with any other aspect.

According to an aspect, there is provided a pressure vessel for a breathing apparatus, the pressure vessel comprising a fibre-reinforced polymer composite shell having a layer of graphene flakes.

The pressure vessel may further comprise a liner (e.g., the vessel may be a Type IV cylinder), e.g., within the composite shell. The liner may be a non-metallic liner, e.g., a plastic or polymeric liner. The composite shell may encapsulate the liner, for example so as to protect or increase the strength and/or structural integrity of the liner. Alternatively, the pressure vessel may not comprise a liner (e.g., the vessel may be a Type V cylinder).

The fibre-reinforced polymer composite may comprise a fibre reinforcement in a polymer matrix. The fibre reinforcement may comprise a plurality of fibres, e.g., in tows. The fibre reinforcement may comprise a plurality of fibre layers (e.g., two or more fibre layers). Each fibre layer may be a layer of fibre tows. The fibre reinforcement may comprise a first fibre layer. The fibre reinforcement may comprise a second fibre layer.

The first fibre layer may comprise fibres wound in a first orientation (e.g., hoop-, polar- or helically wound). The second fibre layer may comprise fibres wound in a second orientation (e.g., hoop-, polar- or helically wound). The first orientation may be different from the second orientation.

The composite may comprise multiple graphene layers (e.g. multiple layers of graphene flakes). A, the or each graphene layer (e.g., layer of graphene flakes) may be provided within (e.g., enveloped by) the matrix. The layer of graphene flakes may not comprise other forms of graphene. The layer of graphene flakes may additionally comprise the matrix, such that if not in contact, adjacent graphene flakes within the layer may be spaced apart by the matrix.

A graphene layer may be provided adjacent a fibre layer. A graphene layer may be provided between the liner and the fibre reinforcement (e.g., a first layer of fibre reinforcement). The liner may be spaced apart from the fibre reinforcement (e.g., a first layer of fibre reinforcement) by a graphene layer.

The first and second fibre layers may be spaced apart by a graphene layer. The graphene flakes may be formed or configured in at least one intermediate layer between two of the fibre layers. An intermediate layer of graphene flakes may be formed between each pair of adjacent fibre layers. The shell may comprise a plurality of alternating fibre and graphene layers. Successive fibre layers may be wound in different orientations.

The graphene flakes may be provided in layers (e.g., in layers only). The graphene flakes may not be distributed uniformly throughout the matrix. The concentration of graphene throughout the shell may form a rectangular wave. Graphene layers may be spaced apart by layers having no graphene flakes. The graphene flakes may be provided in substantially discrete and/or discontinuous layers. The layers may be spaced apart along a thickness or radial direction of the pressure vessel wall or shell. Graphene flakes may not be dispersed within a fibre layer. Graphene flakes may not be present between fibres or fibre tows in the same orientation (e.g., within the same fibre layer). Graphene flakes or layers may be present only between layers of fibre tows oriented or wound in different directions.

The composite shell may comprise a plurality of layers (e.g., concentric and/or stacked layers), including a first fibre layer and a first graphene layer. The plurality of layers may additionally comprise a second fibre layer and/or a second graphene layer.

Within the or each graphene layer, the graphene flakes may be generally aligned (e.g., substantially aligned), generally coplanar (e.g., substantially coplanar) and/or generally parallel (e.g., substantially parallel) with one another. The graphene flakes may be generally parallel (e.g., substantially parallel) to a local circumferential surface of the cylinder. For example, graphene flakes may be oriented substantially perpendicular to a local radius or thickness direction of the vessel (which may be generally cylindrical with hemispherical ends). The graphene flakes may thus be oriented generally perpendicular to a local direction of diffusion across the shell.

The or each graphene layer may comprise graphene flakes generally oriented at low angles to one another and/or to a local circumferential surface of the vessel. For example, the graphene flakes may generally be at angles of no greater than 45 degrees, preferably no greater than 30 degrees, most preferably no greater than 15 degrees, to one another and/or to a local circumferential surface of the vessel.

The reduced CBRN permeability of the or each graphene layer may be formed by the aggregate properties of a large number of graphene flakes. For example, each graphene flake individually may be impermeable to CBRN contaminants, and so a large number of flakes in a layer may form a tortuous diffusion path for CBRN contaminants. There may be gaps and discontinuities between adjacent graphene flakes within the layer. For example, the layer may not comprise a continuous sheet or foil of graphene. Nevertheless, the or each graphene layer may provide a tortuous path through the vessel wall so as to inhibit inward permeation of CBRN agents and/or outward permeation of breathing gases.

The graphene flakes may thereby form one or more permeation barrier layers within the composite shell. The permeation barrier layer or layers may be organised as intermediate layers between fibre layers. The pressure vessel may thereby comprise a permeation barrier layer comprising aggregated graphene flakes.

The or each layer of graphene flakes may extend about the cylinder (e.g., continuously about the cylinder). For example, a fibre tow (e.g., either pre-preg or wet wound) may be wound around the whole cylinder in a first orientation so that the matrix coating (include graphene flakes) formed on the surface of a first section of the fibre tow may be placed adjacent the matrix coating (include graphene flakes) on the surface of a second section of fibre tow. The matrix coatings may then merge with one another (e.g., during curing) so as to form a single layer of graphene flakes.

The graphene flakes may initially be randomly oriented within a liquid matrix. However, when the liquid matrix impregnates the fibre reinforcement, the wicking of the matrix into the fibre reinforcement may act to increase the alignment between the graphene flakes.

The flakes may have a thickness, an in-plane minor axis and an in-plane major axis. The thickness of each flake may be substantially smaller than the in-plane dimensions. The thickness of the flakes may be at least an order of magnitude smaller than the in-plane dimensions. The flakes may be substantially planar.

The graphene flakes may have an in-plane major axis dimension, and/or an in-plane minor axis dimension, greater than a fibre diameter of the fibre reinforcement. The graphene flakes may have a major axis dimension and/or minor axis dimension at least twice, optionally thrice, the fibre diameter. The graphene flakes may have a major axis dimension of about 8-50 micrometres. The graphene flakes may have a major axis dimension of about 20 micrometres. Each fibre filament of the fibre reinforcement may have a uniform diameter. The fibre diameter may be about 3-10 micrometres. It should be understood that graphene flakes may not have a precise or regular shape. The major dimension of a graphene flake may be the largest dimension which can be measured across the flake.

The layer of graphene flakes may comprise single layer flakes of graphene, few layer flakes of graphene (e.g., 2-5 layers) or multi-layer flakes (e.g., up to 10 layers). The graphene may comprise functionalised graphene. For example, the graphene may comprise graphene oxide or another functional group.

The fibre reinforcement may comprise (e.g., consist essentially of) carbon fibres and/or aramid fibres. The matrix may comprise a thermoplastic matrix (e.g., acrylic, nylon, polyetheretherketone (PEEK), polyphenyl sulphide (PPS), polyetherimide, polycarbonate or polypropylene matrix). The matrix may comprise a thermoset matrix (e.g., epoxy, polyester, vinyl ester, phenolic, bismaleimide, polyimide).

The matrix may comprise up to around 10% graphene flakes by weight. Optionally, the matrix may comprise up to around 8% graphene particles by weight. In particular, the matrix may comprise between 0.1% and 2% graphene particles by weight, or in a particular example, 1% graphene particles by weight. The matrix may comprise at least 0.1 wt. % graphene flakes. As gravity is assumed to be constant, proportion by mass and proportion by weight may be interchangeable. The composite may comprise 60-65 wt. % fibre reinforcement and 35-40 wt. % matrix, of which 0.1-10 wt. % may be graphene flakes.

The present aspect may form part of and/or be used in conjunction with any other aspect.

According to an aspect, there is provided a method of manufacturing a pressure vessel, e.g., for a breathing apparatus. The method may comprise providing a matrix (e.g., a polymer matrix such as a resin). The matrix may comprise graphene flakes, e.g., in a resin material. The method may comprise impregnating a plurality of fibres (e.g., a fibre reinforcement) with the matrix. The method may additionally comprise curing the matrix and the fibres to form a shell of a pressure vessel. The present aspect may form part of and/or be used in conjunction with any other aspect.

According to an aspect, there is provided a method of manufacturing a pressure vessel for a breathing apparatus, the method comprising: providing a polymer matrix having at least 0.1 wt. % graphene flakes; impregnating a fibre reinforcement with the matrix.

The fibres may be pre-impregnated with the matrix. In other words, the fibres may be pre-preg fibres. Pre-preg fibres may typically be impregnated with matrix, ‘B-staged’ chemically or thermally to partially cure the matrix (e.g. with heat or UV), then wound onto a spool. The pre-preg fibres may then be unwound from the spool to be used. The method may comprise pre-impregnating a fibre reinforcement. The method may further comprise B-staging a fibre reinforcement.

The graphene flakes may be suspended or incorporated into a matrix. The graphene flakes may be dispersed (e.g., consistently or uniformly, such as by agitation) throughout the matrix. The graphene flakes may be added to the matrix (e.g., resin) prior to impregnation into the fibre reinforcement.

The shell may be wet-wound. The impregnating step may comprise impregnating the fibre by drawing the fibre through the matrix, such as through a bath of the matrix. The method may comprise wet-winding the fibre reinforcement.

The plurality of fibres may be wound around a liner or mandrel. The winding may take place before the curing. The winding may comprise helical, hoop, polar and/or cylindrical winding. End caps may be provided on the liner before winding.

If pre-preg fibres are used, then these may be would directly onto the liner from a spool. This may have the advantage of reducing the number of manufacturing steps required when manufacturing the pressure vessel. If non-pre-preg fibres are used, then the impregnating step may take place between unwinding the fibre from a spool and winding the fibre onto the liner.

The curing may comprise flowing the matrix so as to form one or more layers of graphene within the shell. The matrix, optionally a resin material of the matrix, may flow during curing to align the graphene particles. The resin may set during curing to form a rigid matrix which secures the graphene particles in place.

The method may comprise winding the fibre reinforcement around a liner or a mandrel in a first orientation to form a first layer of fibre reinforcement. The method may comprise winding the fibre reinforcement around the liner or the mandrel in a second orientation to form a second layer of fibre reinforcement. The second orientation may be different from the first orientation.

The present aspect may form part of and/or be used in conjunction with any other aspect.

According to an aspect, there is provided a pressure vessel for a breathing apparatus comprising a structural shell and a liner. The pressure vessel further comprises at least one permeation barrier layer comprising graphene flakes. The permeation barrier layer may be provided on an outer surface of the structural shell or on an outer surface of the liner. The structural shell may be a composite shell. The composite shell may comprise fibres and a matrix.

The present aspect may form part of and/or be used in conjunction with any other aspect.

According to an aspect, there is provided a method of manufacturing a pressure vessel for a breathing apparatus, the method comprising: providing a mould for forming a liner of the pressure vessel; coating at least a portion of the mould with graphene microparticles and/or graphene nanoparticles (e.g., graphene flakes); then introducing a liner material to the mould to thereby form a liner, such that the liner comprises the graphene microparticles or graphene nanoparticles on an outer surface thereof.

The graphene microparticles and/or graphene nanoparticles may be suspended or incorporated into a resin or fluid for coating the mould.

The mould may comprise an interior volume defining a shape for the liner. The interior volume may be defined by an inner surface of the mould. The graphene particles may be applied to a portion of the inner surface of the mould.

The present aspect may form part of and/or be used in conjunction with any other aspect.

The skilled person will appreciate that, except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

### BRIEF DESCRIPTION OF DRAWINGS

Embodiments will now be described by way of example only, with reference to the Figures, in which:

FIG. 1 is a sectional side view of a pressure vessel for a breathing apparatus;

FIG. 2 is a detailed sectional view of the pressure vessel of FIG. 1;

FIG. 3 is a schematic illustration of the structure of a shell of a pressure vessel;

FIG. 4 is a schematic illustration of a graphene flake for use in a pressure vessel or method of manufacture thereof;

FIG. 5 schematically shows a method for manufacturing a pressure vessel;

FIG. 6 shows an apparatus for manufacturing a pre-preg fibre tow;

FIG. 7 shows an apparatus for manufacturing a pressure vessel from pre-preg fibre tows;

FIG. 8 shows an apparatus for manufacturing a pressure vessel using wet-winding of fibre tows;

FIG. 9 shows a sectional side view of an alternative pressure vessel for a breathing apparatus;

FIG. 10 is a detailed sectional view of the pressure vessel of FIG. 9; and

FIG. 11 schematically shows a method for manufacturing a pressure vessel.

### DETAILED DESCRIPTION

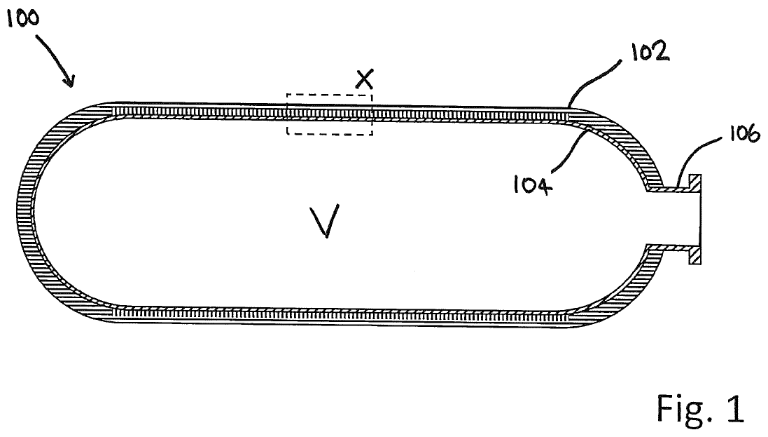

FIG. 1 schematically shows a cross-sectional view of a pressure vessel 100 for a breathing apparatus (not shown). In this example, the pressure vessel 100 is a breathing air vessel. The breathing apparatus may be a self-contained breathing apparatus (SCBA) or a closed-circuit breathing apparatus (CCBA).

The pressure vessel 100 comprises a hollow, generally cylindrical, body having hemispherical ends. In other examples, the pressure vessel 100 could have a different shape, such as tori-spherical ends.

The pressure vessel 100 comprises a composite shell 102 and a liner 104, which define an internal volume or chamber V. In this example, the liner 104 is encapsulated by the composite shell 102. The liner 104 is a plastic liner, but could in other examples be formed from other materials, such as metal (e.g. aluminium, steel, or alloys). The liner could, for example, be formed from PA6 nylon, polyethylene terephthalate (PET), or high-density polyethylene (HDPE) among other plastics, dependent upon the requirements and manufacturing process to be used.

The liner 104 performs the primary function of providing a barrier to retain the fluid within the pressure vessel 100, and the composite shell 102 encapsulates the liner 104 so as to protect the liner 104 and increase the strength and structural integrity of the vessel 100. The liner 104 may be substantially impermeable to the fluid it is designed to contain, e.g. breathing air, but may not be fully impermeable to other substances, such as CBRN contaminants.

The liner 104 has a neck portion 106 which protrudes from the composite shell 102 at one hemispherical end of the pressure vessel 100. The neck portion 106 is connectable to a breathing apparatus such that the contents of the pressure vessel can be supplied to the breathing apparatus. The neck portion 106 may be formed as a separate piece formed from a different material to the rest of the liner 104. For example, the neck portion 106 may constructed from metal, and the rest of the liner 104 may be formed from plastic and blow moulded around the neck portion 106 to connect the two parts. In some examples, a further fitting may be provided at the opposing hemispherical end, for example to permit positioning and/or gripping of the liner 104 and vessel 100 while it is being manufactured. In other examples, the neck portion, or part thereof, may be provided as a separate component to be installed after manufacture of the liner and/or shell.

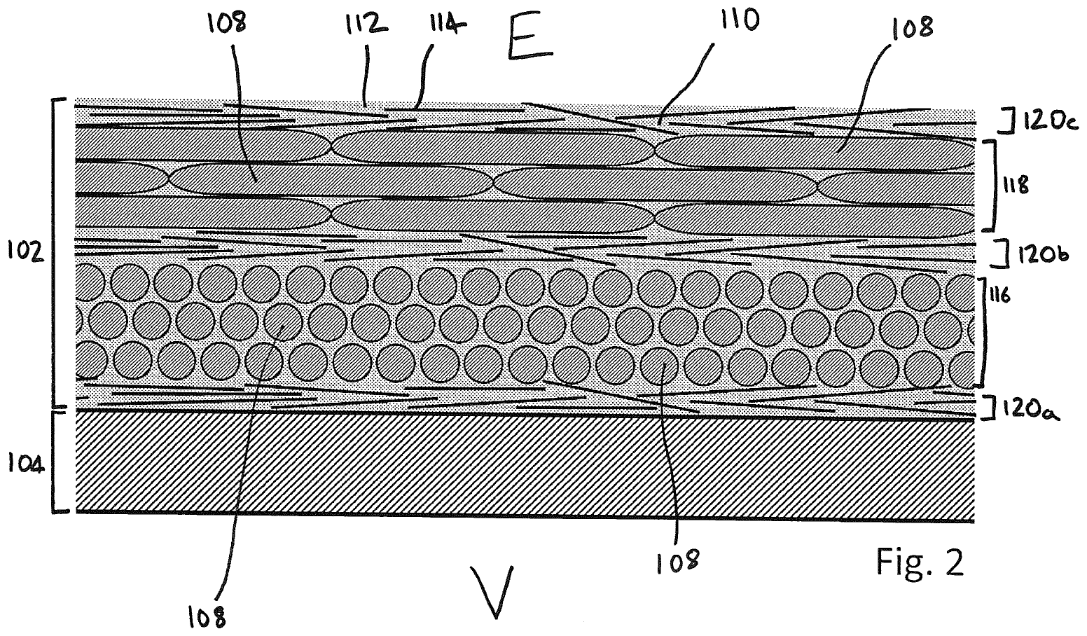

Turning now to FIG. 2, a detailed view of the cross section of the pressure vessel 100 is shown. FIG. 2 shows an exemplary portion of the pressure vessel 100 indicated at X in FIG. 1. In FIG. 2, the layering and construction of the composite shell 102 and the liner 104 can be seen more clearly.

Referring first to the liner 104, it can be seen that the liner 104 is a substantially homogenous layer of material, in this case plastic. The liner 104 is arranged so as to form the innermost surface of the pressure vessel 100 which faces the internal volume V.

The composite shell 102 overlays the liner 104 and, in this example, forms the outermost surface of the pressure vessel 100 which is exposed to the external environment E. In other examples, the shell 102 may itself be overlain by another layer or layers of material or composite, such as a further protective layer and/or decorative layer, which would then form the outermost surface of the pressure vessel 100.

As can be appreciated in FIG. 2, the composite shell 102 comprises a number of components. Generally, the composite shell 102 is formed from a plurality of fibres 108 and a matrix 110. The matrix 110 substantially envelops the fibres 108 and itself comprises two main parts: a resin material 112 and graphene particles 114. The matrix may comprise up to around 10% graphene particles by weight. In some examples, the matrix may comprise up to around 8% graphene particles by weight. In particular, the matrix may comprise between 0.1% and 2% graphene particles by weight, or in a particular example, 1% graphene particles by weight. The matrix may comprise a resin in which the graphene particles are distributed, for example an epoxy resin. The composite may comprise 60-65 wt. % fibre reinforcement and 35-40 wt. % matrix, of which 0.1-10 wt. % may be graphene flakes.

During manufacture, as will be described in more detail below, the resin material 112 is initially liquid in form, and the graphene particles 114 are substantially evenly dispersed within the resin material 112. The matrix 110 in this liquid form is coated on the fibres 108 and the fibres 108 are wound onto the liner 104 in layers. Once wound onto the liner 104, the matrix 110 is cured such that the resin material 112 hardens and the graphene particles 114 are set into their layers. Thus, during curing the matrix may flow so as to order the graphene particles within the shell.

In this schematic exemplary illustration of the pressure vessel 100, two fibre layers 116 and 118 are shown. It should be understood that in other examples, many more fibre layers may be provided.

It can also be appreciated in this example, that the graphene particles 114 in the matrix 110 form alternating layers 120a, 120b, and 120c with the fibre layers 116,118. One of the graphene layers 120b forms an intermediate layer between the two fibre layers 116,118. Where more than two fibre layers are provided, an intermediate layer of graphene particles may be formed between each pair of fibre layers. More generally, the shell 102 may comprise a plurality of alternating fibre and graphene layers.

The inner fibre layer 116 is wound as a ‘hoop’ winding layer. Prior to winding, the fibres are organised into tows, which are dense discreet bundles of fibres 108. Tows are generally substantially flat in cross section, having a width of 1-5 mm and a thickness, t_{f}, of less than 1 mm. It should be understood that a tow of fibres is extremely densely packed such that each tow can be handled like an elongate tape. It should also be understood that, once the shell 102 is cured, the discrete tows of fibres 108 may no longer be discernible as the matrix and fibres become homogenised.

The tows are wound around the cylindrical portion of the pressure vessel 100 between the hemispherical ends at an angle as close to perpendicular to the axial direction of the pressure vessel 100 as possible, typically at around 87 degrees to the axial direction. Therefore, when viewed in a cross-sectional plane along the axis of the vessel 100 per FIGS. 1 and 2, the fibre tows are viewed substantially perpendicularly to their length and appear substantially circular in cross-section. The hoop layer 116 predominantly resists radial expansion of the liner 104 when the vessel 100 is pressurised.

The outer fibre layer 118 is wound as a ‘helical’ winding layer. The tows are wound along the entire pressure vessel 100 at an angle to the axial direction of the vessel, typically around 10-15 degrees thereto, and over the hemispherical ends. As such, when viewed in a cross-sectional plane along the axis of the vessel 100 per FIGS. 1 and 2, the fibres are viewed obliquely to their length and appear as elongate ellipses in cross-section. The helical layer 116 predominantly resists axial expansion of the liner 104 when the vessel 100 is pressurised.

Alternating hoop and helical fibre layers may be provided, or a number of adjacent hoop or helical layers may be provided, or any combination thereof. In some examples, a high-angle helical wrap or ‘knuckle’ wrap may also be used, having fibres wound at around 55-70 degrees to the axial direction of the vessel.

The resin material 112 coats and encapsulates the fibres 108 and the graphene particles 114. The resin material 112 fills the interstitial spaces between the fibres 108 and particles 114.

The graphene particles 114 reduce the permeability of the composite shell 102 to harmful substances, such as CBRN contaminants, and therefore inhibit the ingress of such substances into the internal volume V of the pressure vessel 100. Accordingly, pressure vessels according to the present disclosure may improve the safety of breathing apparatuses being used in CBRN contaminated environments. Similarly, the graphene particles 114 inhibit the egress of breathing air out from the internal volume V.

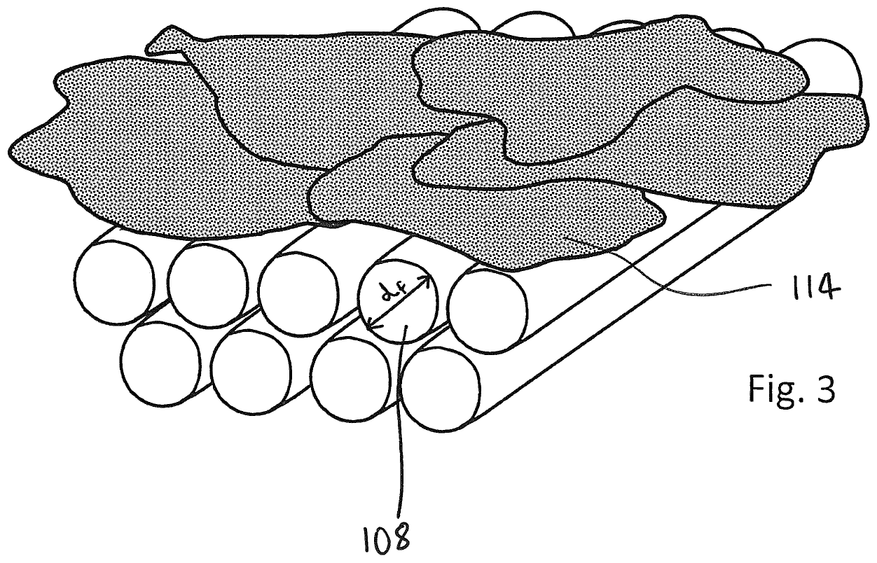

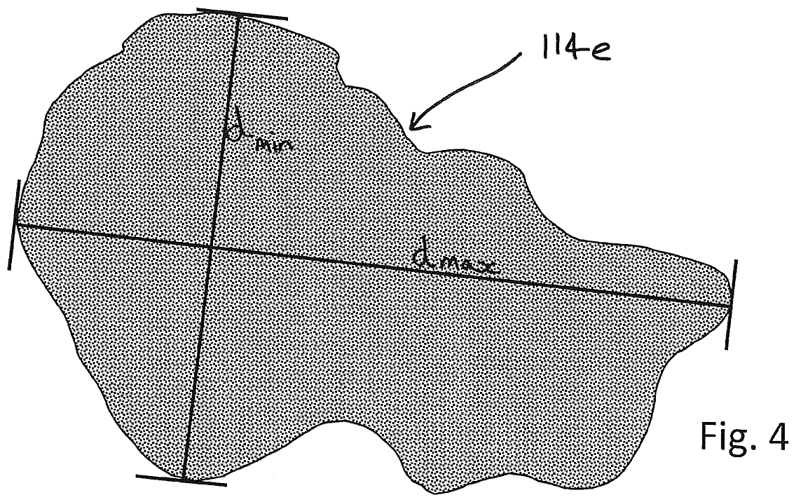

With reference to FIGS. 3 and 4, the graphene particles 114 and their configuration in the composite layer will be described in more detail.

The graphene particles 114 are graphene flakes 114. The flakes are substantially planar in form. An exemplary graphene flake 114e is shown in FIG. 4. The flake 114e has a thickness (which is in the dimension into/out of the FIG. 4) which is much smaller than its other dimensions, for example at least an order of magnitude smaller than the width and height of the flake 114e.

Each graphene flake 114, such as the exemplary flake 114e, has a major axis, dₘₐₓ, which spans the largest distance across the flake 114. Each flake 114 also has a minor axis, dₘᵢₙ, across the flake 114 in the same plane as the major axis, dₘₐₓ. In this example, the minor axis, dₘᵢₙ, is the largest distance across the flake 114 perpendicular to the major axis, dₘₐₓ, in the plane of the flake 114. It should be understood that the major and minor axes, dₘₐₓ and dₘᵢₙ, are the two largest perpendicular dimensions across the plane of the flake 114. It should be further understood that graphene particles or flakes may not have a precise or regular shape.

Referring now to FIG. 3, the layering of the graphene flakes 114 in the composite shell 102 will be described.

The fibres 108 in the shell are formed into tows, which may comprise several thousand fibres each, typically 3000-100000 for carbon fibres, or less than 3000 fibres for other fibre types such as aramid. Here, only a small number of fibres 108 are shown for simplicity. Typically, each fibre 108 is substantially cylindrical having a diameter, d_{f}. It should be understood that a tow of fibres is extremely densely packed such that each tow comprises a plurality of fibres which may be stacked on top of one another to form a layer several fibres in thickness (i.e. multiple times d_{f} in thickness).

The graphene flakes 114 are specially selected such that their minor axes, dₘᵢₙ, are larger than the diameter, d_{f}, of the fibres 108, and preferably 2 or more times larger than the diameter of the fibres 108. Accordingly, when the fibres 108 are tightly wound into a layer, as schematically shown in FIG. 3, the graphene flakes 114 cannot fit into the interstitial spaces between the fibres 108, and overlap one another to form a graphene flake layer, like layers 120a,b,c in FIG. 2, which is arranged adjacent the layer of fibres 108. Although in FIG. 3 the graphene flakes 114 are shown only on one side of the fibres 108, they may be present on both sides of the fibres, meaning a layer of graphene may be formed above and below each fibre layer.

Furthermore, during curing of the resin 112, the pressure applied to the shell 102 may encourage any flakes 114 which are trapped between fibres 108 or not substantially aligned with the other flakes 114 to become aligned into a layer.

The graphene flakes 114 within each layer 120a,b,c are generally at low angles to one another (e.g., approximately 15 degrees), and further oriented generally perpendicularly to the diffusion direction across the shell 102.

It should be understood that the size of the graphene particles will be dependent upon the dimension of the fibres in the shell. In a particular example, the graphene particles may have a minor axis of around 8-50 micrometres, and optionally around 20 micrometres, and the fibres may have a diameter around 3-10 microns, meaning a single graphene flake may typically cover around 2-5 fibres.

The graphene particles 114 in the layer or layers 120 are substantially impermeable to harmful CBRN substances, meaning that CBRN substances may only permeate around the graphene particles 114 in the resin material 112. As the graphene particles 114 substantially overlap in the layers 120, the available permeation paths for CBRN substances through each graphene layer 120 are highly tortuous, such that permeation through the composite shell 102 as a whole is substantially inhibited or even eliminated.

It will be understood therefore that in this example, the graphene particle layers 120 are permeation barrier layers, and in particular CBRN permeation barrier layers.

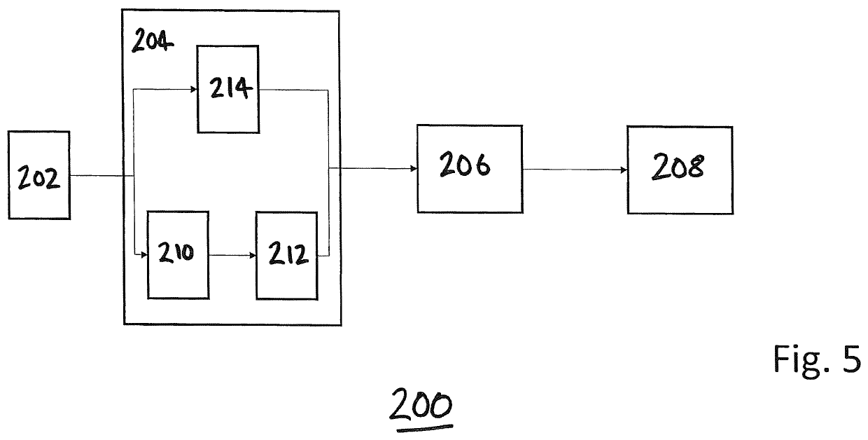

Turning now to FIGS. 5-8, methods of manufacturing a pressure vessel for a breathing apparatus will now be discussed.

Generally, FIG. 5 shows a method 200 of manufacturing a pressure vessel for a breathing apparatus comprising: providing a polymer matrix having at least 0.1 wt. % graphene flakes; and impregnating a fibre reinforcement with the matrix.

In FIG. 5, a first block 202 represents providing a polymer matrix having at least 0.1 wt. % graphene flakes. Block 204 represents impregnating a fibre reinforcement with the matrix. Block 206 represents winding the impregnated fibres onto a liner, and block 208 represents curing the matrix and the fibres to form a shell of the pressure vessel. Each of these processes will now be described in more detail.

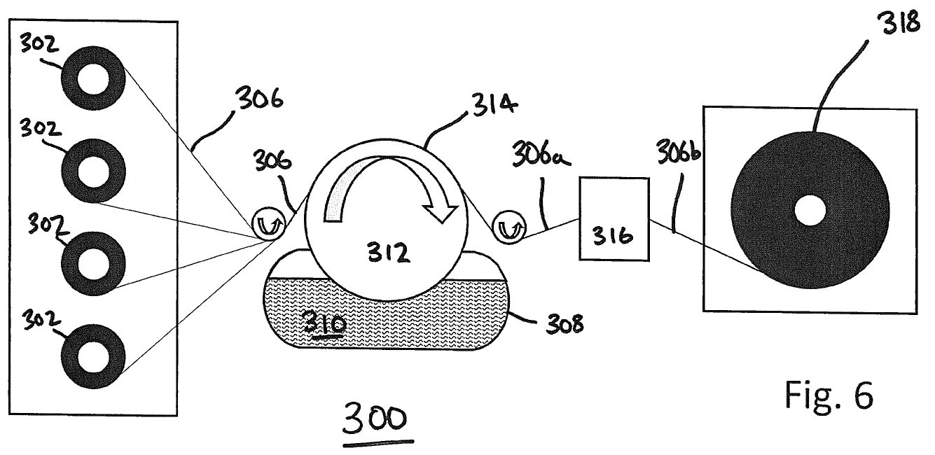

In FIG. 6, an apparatus 300 for forming pre-impregnated or ‘pre-preg’ fibre tows is shown.

One or more fibre tow spools 302 are provided, and a fibre tow 306 is drawn from each spool 302. A bath 308 of liquid matrix 310 is provided, having a roller 312 which is partially submerged into the liquid matrix 310. As discussed above, the matrix 310 comprises graphene particles, in particular graphene flakes. This is equivalent to block 202 of FIG. 5. An agitation method may be used to ensure that the graphene particles are dispersed within the matrix 310 and/or to ensure that the matrix 310 is applied consistently to the tows 306.

The roller 312 is rotated such that it provides a continuous matrix-coated surface 314, over which each fibre tow 306 is drawn so as to impregnate the fibre tow 306 with the matrix comprising the graphene flakes so as to provide an impregnated fibre tow or tows 306a. In other examples, the fibre tow may be drawn directly through (i.e. submerged in) the matrix bath 308. An agitation method may be used to ensure that the graphene flakes are dispersed within the matrix and to ensure even coverage of matrix on the fibre tow.

Following impregnation with liquid matrix, each impregnated fibre tow 306a is, in this example, subjected to a ‘B-staging’ process by a curing apparatus 316. During B-staging, the matrix 310 is partially cured such that the matrix 310 is retained on the fibre tow for transit to another destination. It should be understood that B-staging may not be required for some matrix types.

Following B-staging, if used, the fibre tow is now a pre-preg fibre tow 306, or ‘tow-preg’. The pre-preg fibre tow 306b is then wound onto a pre-preg spool 318 for storage and transit.

With reference to FIG. 5, the impregnation of the fibres 204 in this example therefore comprises two steps: impregnating the fibres, which is represented by block 210, and forming a pre-preg fibre (e.g. by optionally B-staging and re-spooling), which is represented by block 212.

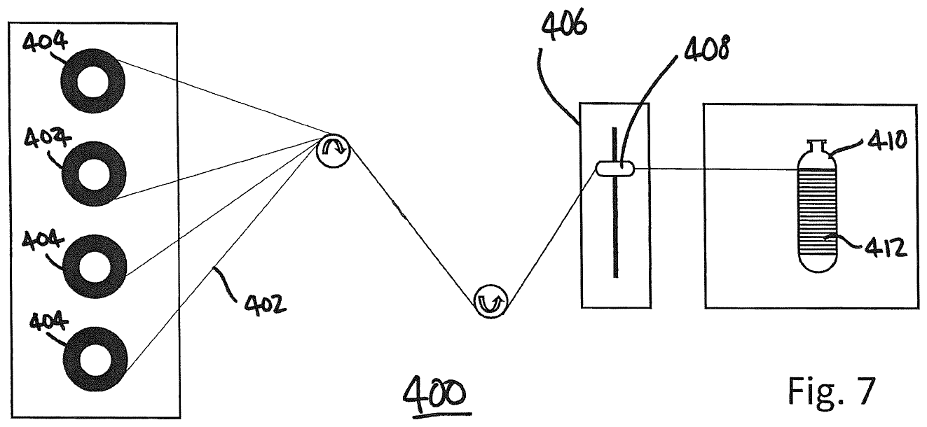

FIG. 7 shows an apparatus 400 for manufacturing a pressure vessel which utilises pre-preg fibres, such as those manufactured by the apparatus 300 of FIG. 6.

One or more pre-preg fibre tows (‘tow-pregs’) 402 are provided on spools 404. It should be understood that in some examples, only one fibre and spool may be used.

The tow-pregs 402 are fed to a winding apparatus 406 which comprises one or more winding heads 408. In this example, only one winding head 408 is shown for simplicity. In other examples, there may be multiple winding heads, such as a winding head for each tow-preg. The winding apparatus 406 is configured to wind the tow-pregs 402 onto a liner 410 using the winding head (or heads) 408. Thus, by moving the winding head 408 relative to the liner 410, the winding apparatus 406 forms a fibre layer or layers 412 on the liner 410. The winding apparatus may apply the tow-pregs 402 as helical windings and/or cylindrical windings. This winding of the fibres onto the liner by the winding apparatus is represented by block 206 in FIG. 5.

Finally, following winding (or other application of the fibres and matrix to the liner), the liner 410 which is covered by fibre layers 412 is cured so as to harden the fibres and their associated matrix into a shell of the pressure vessel, as represented by block 208 of FIG. 5.

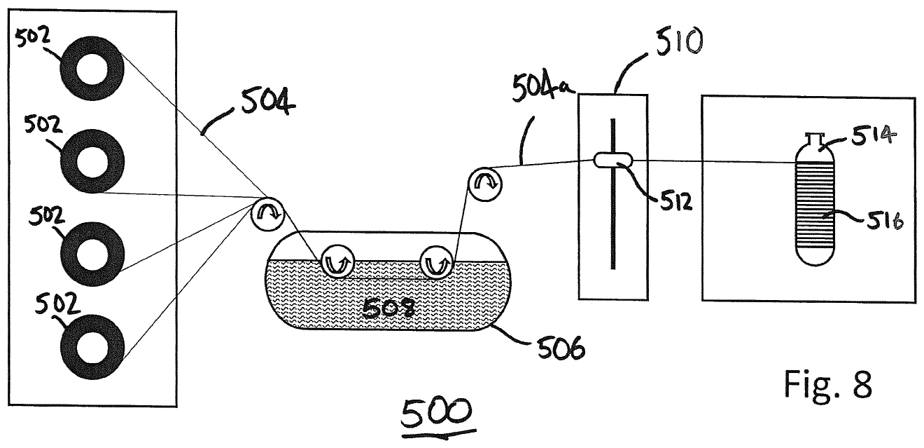

FIG. 8 shows an alternative apparatus 400 for manufacturing a pressure vessel. In this case, the apparatus 400 uses ‘wet-winding’ of fibres.

A plurality of fibre tow spools 502 are provided. In some examples, the fibre spools may dispense single dry fibres for a ‘filament winding’ process, but in this example, ‘dry’ fibre tows 504 are wound off the spools 502.

A bath 506 of liquid matrix 508 is provided. The matrix 508 comprises graphene particles, in particular graphene flakes. This is equivalent to block 202 of FIG. 5. An agitation method may be used to ensure the matrix 508 is applied consistently to the tow and/or to ensure that the graphene flakes are dispersed within the matrix.

The apparatus 500 is configured to draw (i.e. submerge) the fibre tows 504 through the matrix bath 506, to thereby impregnate the fibres with the matrix comprising the graphene flakes, thereby producing impregnated fibre tows 504a. This wet-winding impregnation process is represented by block 204 of FIG. 5, and more specifically by block 214.

The impregnated fibre tows 504a are then fed directly to a winding apparatus 510 which comprises one or more winding heads 512. In this example, only one winding head 512 is shown for simplicity. In other examples, there may be multiple winding heads, such as a winding head for each fibre tow. The winding apparatus 510 is configured to wind the impregnated fibre tows 504a onto a liner 514 using the winding head (or heads) 512. Thus, by moving the winding head 512 relative to the liner 514, the winding apparatus 510 forms a fibre layer or layers 516 on the liner 514. The winding apparatus may apply the impregnated fibre tows 504a as helical windings and/or cylindrical windings. This winding of the fibres onto the liner by the winding apparatus is represented by block 206 in FIG. 5. It should be understood generally in this wet-winding process, the impregnating of the fibres may take place immediately before winding the fibre onto the liner, i.e. between unwinding the fibre tow from the spool and winding the fibre onto the liner in a continuous process.

Finally, following winding (or other application of the fibres and matrix to the liner), the liner 514 which is covered by fibre layers 516 is cured so as to harden the fibres and their associated matrix into a shell of the pressure vessel, as represented by block 208 of FIG. 5.

It should be understood that the processes and apparatuses as disclosed in the examples of FIGS. 6/7 and FIG. 8 have some common features, such as providing the matrix (block 202), winding the fibres onto the liner (block 206), and curing (block 208), but differ predominantly in how the fibres are impregnated with matrix before winding. This is represented by the specific alternatives of blocks 210/212 and block 214 within the general impregnating block 204.

In the curing process represented by block 208 may comprise flowing the matrix so as to set the one or more layers of graphene within the shell.

It should be understood that, regardless of the method by which the fibre tows are impregnated, during impregnation, much of the resin in the liquid matrix will ‘wick’ into the fibre tow, and leave the graphene particles on the surface of the tow, as schematically shown in the example of FIG. 3. As the graphene particles may sit on all sides of the fibre tow, a layer of graphene may be formed above and below each fibre layer.

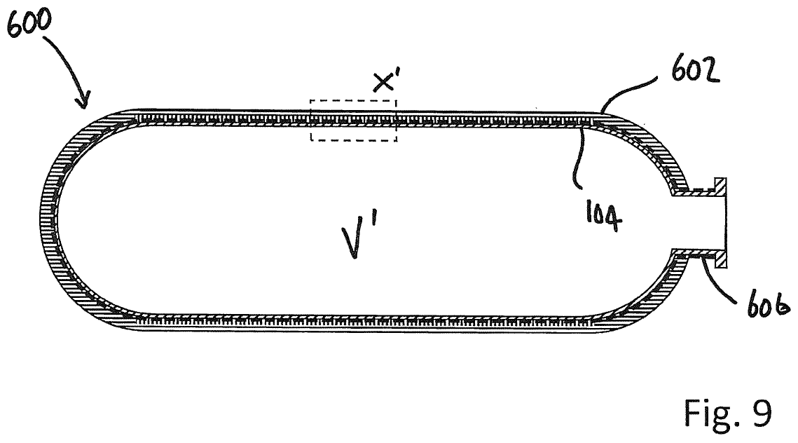

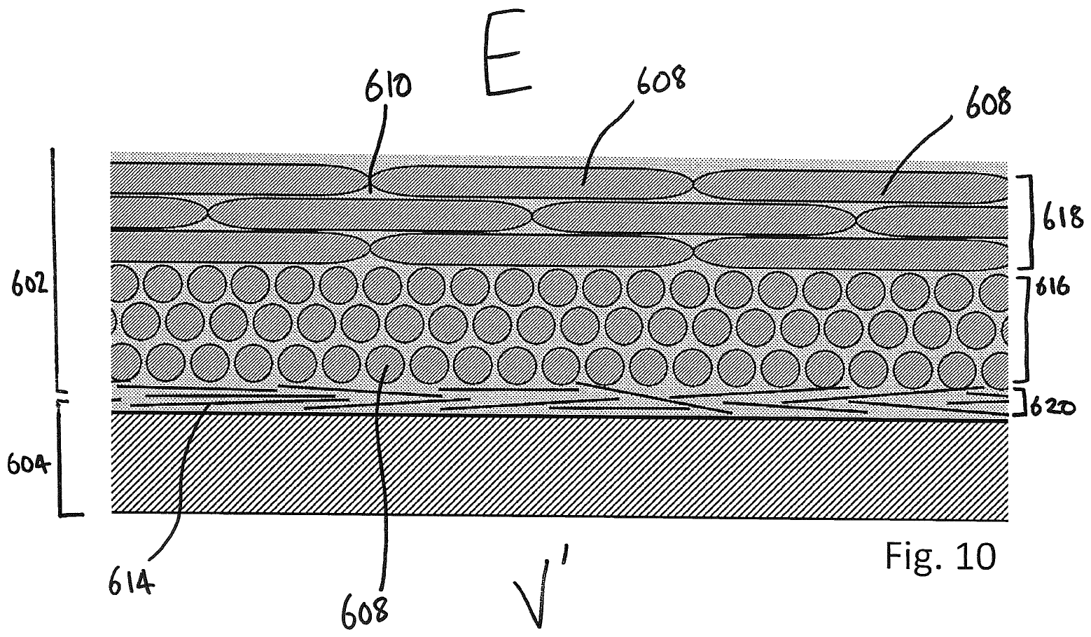

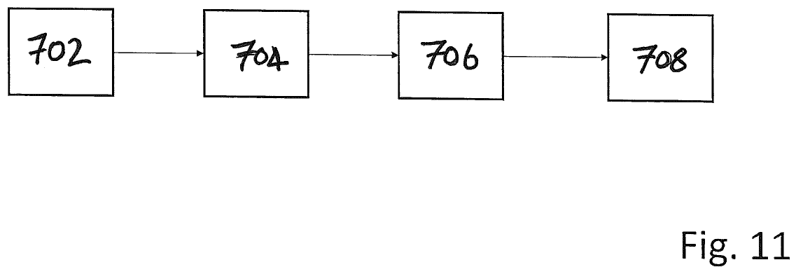

Referring to FIGS. 9 and 10, a further alternative pressure vessel 600 is disclosed. A further alternative method 700 for manufacturing a pressure vessel is disclosed, with reference to FIG. 11

FIG. 9 schematically shows a cross-sectional view of a pressure vessel 600 for a breathing apparatus (not shown). In this example, the pressure vessel 600 is a breathing air vessel. The breathing apparatus may be a self-contained breathing apparatus (SCBA) or a closed-circuit breathing apparatus (CCBA).

The pressure vessel 600 comprises a hollow, generally cylindrical, body having hemispherical ends. In other examples, the pressure vessel 600 could have a different shape, such as tori-spherical ends.

The pressure vessel 600 comprises a structural shell 602 and a liner 604, which define an internal volume or chamber V′. In this example, the liner 604 is encapsulated by the structural shell 602. The liner 604 is a plastic liner, but could in other examples be formed from other materials, such as metal. The liner 604 performs the primary function of providing a barrier to retain the fluid within the pressure vessel 600, and the structural shell 602 encapsulates the liner 604 so as to protect the liner 604 and increase the strength and structural integrity of the vessel 600. The liner 604 may be substantially impermeable to the fluid it is designed to contain, e.g. breathing air, but may not be fully impermeable to other substances, such as CBRN contaminants.

The liner 604 has a neck portion 606 which protrudes from the structural shell 602 at one hemispherical end of the pressure vessel 600. The neck portion 606 is connectable to a breathing apparatus such that the contents of the pressure vessel can be supplied to the breathing apparatus. The neck portion 606 may be formed as a separate piece formed from a different material to the rest of the liner 604. For example, the neck portion 606 may constructed from metal, and the rest of the liner 604 may be formed from plastic and blow moulded around the neck portion 606 to connect the two parts. In some examples, a further fitting may be provided at the opposing hemispherical end, for example to permit positioning and/or gripping of the liner 604 and vessel 600 while it is being manufactured.

Turning now to FIG. 10, a detailed view of the cross section of the pressure vessel 600 is shown. FIG. 10 shows an exemplary portion of the pressure vessel 600 indicated at X′ in FIG. 1. In FIG. 10, the layering and construction of the structural shell 602 and the liner 604 can be seen more clearly.

Referring first to the liner 604, it can be seen that the liner 604 is a substantially homogenous layer of material, in this case plastic. The liner 604 is arranged so as to form the innermost surface of the pressure vessel 600 which faces the internal volume V′.

The structural shell 602 overlays the liner 604 and, in this example, forms the outermost surface of the pressure vessel 600 which is exposed to the external environment E. In other examples, the shell 602 may itself be overlain by another layer or layers of material or composite, such as a further protective layer and/or decorative layer, which would then form the outermost surface of the pressure vessel 600.

As can be appreciated in FIG. 10, in this example, the structural shell 602 comprises a number of components and is therefore a composite shell. In other examples, the shell may be non-composite. Generally, the structural shell 602 is formed from a plurality of fibres 608 and a matrix 610. The matrix 610 substantially envelops the fibres 608 and itself comprises a resin material.

During manufacture, the resin material is initially liquid in form. The matrix 610 in this liquid form is coated on the fibres 608 and the fibres 608 are wound onto the liner 604 in layers. Once wound onto the liner 604, the matrix 610 is cured such that the resin material 612 hardens and the graphene particles 614 are ordered into layers. Thus, during curing the matrix may flow as to set and order the graphene particles into one or more graphene layers within the shell.

In this schematic exemplary illustration of the pressure vessel 600, two fibre layers 616 and 618 are shown. It should be understood that in other examples, many more fibre layers may be provided.

The inner fibre layer 616 is wound as a ‘hoop’ winding layer, as discussed above. The outer fibre layer 618 is wound as a ‘helical’ winding layer as also discussed above. Alternating hoop and helical fibre layers may be provided, or a number of adjacent hoop or helical layers may be provided, or any combination thereof.

The resin material 612 coats and encapsulates the fibres 608 and the graphene particles 614. The resin material 612 fills the interstitial spaces between the fibres 608 and particles 614.

As can be best appreciated in FIG. 10, a layer 620 of graphene particles 614 is provided on an outer surface of the liner 604, i.e. between the inner fibre layer 616 and the liner 604. The graphene particles are graphene flakes as described with respect to FIG. 4 above.

The graphene particles 614 reduce the permeability of the structural shell 602 to harmful substances, such as CBRN contaminants, in the same manner as described for layers 120 above and therefore inhibit the ingress of such substances into the internal volume V′ of the pressure vessel 600. Accordingly, pressure vessels according to the present disclosure may improve the safety of breathing apparatuses being used in CBRN contaminated environments.

Accordingly, the pressure vessel 600 comprises a permeation barrier layer 620 comprising graphene flakes on an outer surface of the liner. In alternative pressure vessels, or in addition in a vessel according to pressure vessel 600, a permeation barrier layer may be formed on an outer surface of the structural shell.

With reference to FIG. 11, a method 700 of manufacturing a pressure vessel for a breathing apparatus is disclosed. In particular, the method 700 is for forming a pressure vessel having a permeation barrier layer on an outer surface of a liner, such as pressure vessel 600 of FIG. 9.

Block 702 represents providing a mould for forming a liner of the pressure vessel. The mould comprises an interior volume defining a shape for the liner. The interior volume is defined by an inner surface of the mould.

Next, at block 704, at least a portion of the inner surface of the mould, and preferably substantially the entire inner surface of the mould, is coated with graphene microparticles or graphene nanoparticles. For example, the graphene particles may be deposited by spraying, painting or any other method for depositing particulates on the inner surface of the mould. The graphene particles may be graphene flakes as described with respect to FIG. 4 above.

Block 706 represents introducing a liner material to the mould to thereby form a liner. In this process, the graphene particles provided on the mould surface adhere to or incorporate with the outermost surface of the liner, such that the manufactured liner comprises the graphene particles on an outer surface thereof.

All of the above pressure vessels could be provided as part of a breathing apparatus and the described methods could be applied during the manufacture of a breathing apparatus.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

For example, a pressure vessel can be envisaged within the principles of this disclosure incorporating the principles of pressure vessel 100 of FIG. 1 and the pressure vessel 600 of FIG. 9, i.e. having a plurality of graphene layers formed by different methods and/or in different positions. Further, the presently disclosed principles could also be applied to manufacturing a pressure vessel with a thermoplastic-based matrix, whereby no ‘curing’ step is required as with a resin-based matrix. Additionally, although described in relation to a pressure vessel having a liner, the pressure vessel (e.g., the pressure vessel 100 of FIGS. 1 and 2) may not comprise a liner 104. The vessel 100 may thereby comprise a Type V cylinder.

Further, although the above has set out one method of forming a pressure vessel comprising a fibre-reinforced polymer composite shell having a layer of graphene flakes, it will be evident that such a pressure vessel may be formed by other methods. For example, methods which are able to provide graphene flakes between the fibre layers more directly may use a proportion of graphene flakes outside the range 0.1 to 10 wt. % and still be capable of forming a composite shell having a layer of graphene flakes.

The present inventors have determined that dispersing graphene flakes within a matrix which is then impregnated into a fibre reinforcement may be a favourable means for increasing the impermeability of a pressure vessel. For example, the incorporating graphene flakes into a matrix and agitating the matrix may have fewer handling difficulties than the use of continuous graphene sheets or foils, or indeed other methods of providing a layer of graphene between fibre layers.

Additionally, the present inventors have determined that the proportions of graphene flakes as described herein may provide an optimal balance between improved impermeability and matrix viscosity. Further, the incorporation of graphene flakes in the matrix in the proportions 0.1 to 10 wt. % may increase the mechanical properties of the shell (e.g., impact resistance).

1. A breathing apparatus comprising a pressure vessel, the pressure vessel comprising:
a fibre-reinforced polymer composite shell having a layer of graphene flakes.

2. A pressure vessel for a breathing apparatus, the pressure vessel comprising:
a fibre-reinforced polymer composite shell having a layer of graphene flakes.

3. The pressure vessel of claim 2, wherein the pressure vessel comprises a non-metallic liner, wherein the layer of graphene flakes is provided between the liner and a layer of fibre reinforcement.

4. The pressure vessel of claim 2, wherein the layer of fibre reinforcement comprises a first fibre layer and a second fibre layer, the first and second fibre layers being spaced apart by a layer of graphene flakes.

5. The pressure vessel of claim 4, wherein the first fibre layer comprises fibres wound in a first orientation, and the second fibre layer comprises fibres would in a second orientation different from the first orientation.

6. The pressure vessel of claim 2, wherein the graphene flakes are oriented such that a CBRN permeability of the composite shell is reduced.

7. The pressure vessel of claim 2, wherein the graphene flakes are generally at low angles relative to one another.

8. The pressure vessel of claim 2, wherein the graphene flakes are oriented generally parallel to a local surface of the pressure vessel.

9. The pressure vessel of claim 3, wherein the graphene flakes have an in-plane major axis dimension greater than a fibre diameter of the fibre reinforcement.

10. The pressure vessel of claim 9, wherein the graphene flakes have an in-plane minor axis dimension at least twice the fibre diameter.

11. The pressure vessel of claim 2, wherein the graphene flakes comprise an in-plane major axis dimension of about 8-50 microns

12. The pressure vessel of claim 2, wherein the fibre-reinforced polymer composite shell comprises a matrix having 0.1 to 10 wt. % graphene flakes.

13. A method of manufacturing a pressure vessel for a breathing apparatus, the method comprising:
providing a polymer matrix having at least 0.1 wt. % graphene flakes;
impregnating a fibre reinforcement with the matrix.

14. The method of claim 13, further comprising:
winding, in a first orientation, the fibre reinforcement around a liner or a mandrel to form a first layer of fibre reinforcement.

15. The method of claim 14, further comprising:
winding, in a second orientation different from the first orientation, the fibre reinforcement around the liner or the mandrel to form a second layer of fibre reinforcement.

16. The pressure vessel of claim 7 wherein the angles are generally no greater than 15 degrees.

17. The pressure vessel of claim 11, wherein the graphene flakes comprise an in-plane major axis dimension of about 20 micrometres.

18. The breathing apparatus of claim 1 wherein the breathing apparatus is a self-contained breathing apparatus (SCBA).

19. The breathing apparatus of claim 1 wherein the breathing apparatus is a closed circuit breathing apparatus (CCBA).

20. The pressure vessel of claim 2 wherein the pressure vessel comprises a liner.
